(19) United States
(12) Patent Application Publication
(10) Pub. No.: US 2025/0392378 A1
(43) Pub. Date: Dec. 25, 2025

(54) Method, implemented by an aerial or spatial device, for communicating with at least one terminal, and associated device, system and computer program

(71) Applicant: ORANGE, ISSY-LES-MOULINEAUX (FR)

(72) Inventors: Jean-Marc KELIF, CHATILLON CEDEX (FR); Emile STEPHAN, CHATILLON CEDEX (FR); Veronica QUINTUNA RODRIGUEZ, CHATILLON CEDEX (FR)

(21) Appl. No.: 19/100,738

(22) PCT Filed: Jun. 15, 2023
(86) PCT No.: PCT/EP2023/066137

§ 371 Date: Feb. 3, 2025

(30) Foreign Application Priority Data
Aug. 5, 2022 (FR) 2208133

(51) Int. Cl. H04B 7/185

(52) U.S. Cl. CPC H04B 7/18521

(57) ABSTRACT

A method implemented by a first aerial or spatial device to transmit data to at least one terminal. The method includes: receiving, from a cooperation entity, information relating to resources of at least one second aerial or spatial device that can be used to transmit data to the at least one terminal; and if a cooperation criterion is verified, triggering a cooperation with the at least one second device as a function of the information to transmit data to the at least one terminal. The cooperation includes: sending, to the at least one second device, second data to be transmitted to the at least one terminal.

### TECHNICAL FIELD

The present invention relates to the general field of telecommunications, and more particularly to the field of communications via aerial or spatial devices such as satellites or aircrafts (e.g. drones). In particular, the present invention concerns a method implemented by an aerial or spatial device to communicate with at least one terminal and a method implemented by a cooperation entity to communicate with an aerial or spatial device, as well as a device, a cooperation entity, a system, a computer program and an information medium associated therewith. The present invention finds a particularly advantageous application, although in no way limiting, for the implementation of satellite mobile telephone networks.

### STATE OF THE PRIOR ART

The growing user demand for a wireless connectivity with global coverage has led to the emergence of satellite communication systems. There are currently in the state of the art different communication systems that exploit satellites, and allow the users to access a network (e.g. the Iridium network, ou Viasat) regardless of their location. However, the exploitation of the satellite communication systems requires resolving latency and coverage problems.

In general, it is known to use satellites in geostationary orbits in order to deploy satellite communication systems. The satellites in geostationary orbits remain at a fixed position in the sky, and allow obtaining large coverage areas fixed in time. These advantages are nevertheless countered by a number of drawbacks. The geostationary satellites are located at an altitude of about 36,000 km so that the ground-satellite distance leads to high latency and requires significant emission, powers. Moreover, there is no way to reduce this latency, intrinsic to the time of round-trip propagation of the signals between the Earth and the geostationary satellites.

For these reasons, communication systems exploiting satellites in medium or low Earth orbits have been developed. Compared to the geostationary satellites, the distance between the ground and the satellites in medium or low Earth orbits is significantly shorter. Consequently, the communication systems based on satellites in medium or low Earth orbits do not have the aforementioned latency and emission power drawbacks. However, it should be noted that such communication systems each require a constellation comprising a large number of satellites to provide the users with continuous geographical coverage, which leads to significant implementation complexity.

There is therefore a need for a satellite communication system for covering a large geographical area and communicating with terminals efficiently, in terms of rate, reliability, latency.

### DISCLOSURE OF THE INVENTION

The present invention aims to overcome all or part of the drawbacks of the prior art, particularly those set out above.

To this end, according to one aspect of the invention, a method implemented by a first aerial or spatial device to transmit data to at least one terminal is proposed, the method comprising:
receiving, from a cooperation entity, information relating to resources of at least one second aerial or spatial device that can be used to transmit data to said at least one terminal;
if a criterion called cooperation criterion is verified, triggering a cooperation with said at least one second device as a function of said information to transmit data to said at least one terminal, said cooperation comprising sending, to said at least one second device, data called second data to be transmitted to said at least one terminal.

Within the meaning the invention, the term “aerial or spatial device” refer to any device capable of rising into the air such as a drone, a high altitude platform or to any device placed in orbit around a planet (Earth, Mars; . . . ) such as artificial satellites (e.g. telecommunications satellite). According to one particular embodiment, said first and second devices are satellites.

Within the framework of the invention, the “cooperation entity” refers to an entity determining and transmitting said information relating to the resources of said at least one second device, making it possible to set up, if this proves relevant, a cooperation between the aerial or spatial devices. This cooperation entity can be comprised in a ground station, or an entity for managing the aerial or spatial devices, or an aerial or spatial device.

By “resource”, reference is made here to a communication resource which can refer to any type of resource that can be used to communicate data, such as for example a frequency channel, a time slot, a pair consisting of a frequency and of a time interval, etc. Hereinafter, the term “cooperation” is used to refer to the fact that several aerial or spatial devices are involved in a communication with at least one terminal, and more particularly collaborate with each other to transmit data to it. According to one example, a cooperation between several satellites can correspond to the transmission of data from a first satellite to a terminal by using a second satellite as a relay (i.e. satellite repeater). According to another example, an inter-satellite cooperation can correspond to a simultaneous transmission of data by a first and a second satellite to a terminal.

The term “cell” is used here to refer to a terrestrial geographical region covered by a beam emitted by an aerial or spatial communication device. A cell thus refers to a geographical area on Earth in which a beam (more commonly designated by spot) emitted by an aerial or spatial device can convey (i.e. communicate) data, each device being capable of emitting several beams and therefore of covering several cells. More particularly, a cell can correspond to a coverage area, i.e. a geographical area in which the power level of the signal received by a terminal is greater than a certain threshold, for example the power level of the signal received by the terminal is similar to that of a terrestrial cell of the 4G or 5G type and allowing a direct connection of a standardized mobile terminal. By extension, the term “cell” also refers to the lower part of the cone of the beam immediately above this terrestrial geographical region able to contain flying on-board mobile terminals such as drones flying at most a few hundred meters away. Within the context of the invention, the satellites can be in geostationary, medium or low Earth orbits, such that the coverage areas of the different satellites can be fixed or mobile over time.

By “cooperation criterion”, it is understood here a criterion that conditions the implementation of a cooperation between the first device and the second device for the transmission of data to the terminal.

The proposed method allows to improve the performance of a satellite communication system (e.g. a satellite access network), particularly in terms of coverage, rate and reliability.

Indeed, the proposed method allows to implement cooperation between aerial or spatial devices in order to communicate with terminals. For example, several satellites can be used to communicate data to the same terminal. Hereinafter, the resources of an aerial or spatial device that can be used for a cooperation are also called shareable or usable resources.

Such cooperation allows the first device to benefit from the resources of the second device to transmit data to a terminal. In particular, such cooperation can allow the first device to maintain and/or “artificially” increase its coverage area.

Indeed, the first device can benefit, thanks to the cooperation, from the coverage area of the second device to communicate with terminals.

The proposed method allows to increase the power of the signal received by a terminal and thus to improve the signal-to-noise ratio or SINR (Signal-to-Interference plus Noise Ratio) at the level of a receiving terminal. For example, a first satellite can increase the power of the signal received by a terminal by cooperating with a second relay satellite (i.e. a satellite repeater) closer to the terminal. In other words, the first device transmits data to a terminal via the second device. Consequently, the proposed method allows improving the reliability and/or rate of the communications. Within the context of the invention, by improvement of the reliability of the communications, it is meant particularly a reduction in the transmission error probability.

Moreover, the proposed method allows the first device to implement cooperation autonomously and dynamically, which allows to respond to rapid rate variations in the data to be communicated to the terminals. The invention requires only minimal and asynchronous signaling between a ground station and the aerial or spatial devices to implement cooperation, which allows particularly to deploy an aircraft or satellite communication system with a limited number of ground stations.

Moreover, the method allows the cooperation between aircrafts or satellites belonging to different constellations without taking control of the aircrafts or satellites of one constellation by the control entities (e.g. ground stations) of another constellation. By “constellation” it is also meant any set of aircrafts or satellites exploited by the same administrative entity (e.g. the same aircraft or satellite operator) to provide at least one given service (e.g. communications service) and managed by one or more control entities operated by or for this administrative entity.

The autonomy, i.e. the initiative capacity, of the aerial or spatial devices for the implementation of the cooperation, is enabled by sending to the first device said information relating to the resources of the second device that can be used to cooperate. Indeed, following the receipt of this information, the first device has the information required to initiate a cooperation if necessary. In addition, it should be emphasized that the step of receiving said information relating to the usable resources of the second device can be performed asynchronously, i.e. without time constraints, compared to the step of sending the second data to the second device. For example, said information received by the first device can indicate to it that the second device has, for a given period of time (e.g. 1 minute, one hour, one day, etc.), shareable resources. Thus, at any moment during this period of time, the first device can initiate a cooperation with the second device. The sending of this information by the cooperation entity to the first device is therefore not time-constrained. The proposed method therefore allows to implement a low-complexity communication system for performing cooperation between aerial or spatial devices.

According to one embodiment, the first device sends, to said at least one second device, a cooperation query to transmit data to said at least one terminal, the cooperation query comprising control data for the implementation of said cooperation.

The sending of the cooperation query by the first device to the second device can be performed concomitantly to the sending of said second data to be transmitted to the terminal or in a desynchronized manner.

In particular, according to the latter embodiment, the first device initiates a cooperation by issuing a query called cooperation query to the second device, then sends to the second device the data to be relayed to the terminals. Typically, the data to be communicated to the terminals are application data with constraints on the transmission time between the emitter of these data and the terminal, e.g. data from a telephone or Internet communication hosted or not (edge computing application functions, content delivery networks (CDN), clock synchronization, authentication function key distribution, background service data dissemination, etc.) by the first device. Thus, the prior sending of a cooperation query allows the second device to allocate the resources for the cooperation independently of the time constraints on the application data. Furthermore, the cooperation query comprises the control data (e.g. synchronization data, emission powers and spectra, etc.) necessary for the cooperation and whose sending is, according to this embodiment, independent of the time constraints on the application data to be transmitted to the terminals.

This embodiment thus allows to reduce the complexity of implementation of the cooperation between aerial or spatial devices.

According to one embodiment, the information relating to the resources of said at least one second device that can be used is updated, i.e. refreshed, by said cooperation entity.

According to one embodiment, the first device sends first data to said at least one terminal by using a time-frequency resource used by said at least one second device to transmit the second data to said at least one terminal. It should be noted that the first and second data respectively sent by the first device and said at least one second device can be identical or different.

Hereinafter, by “communication channel” reference is made to the transmission medium used to communicate data between the aerial or spatial devices and the terminal. More particularly, the term “communication channel” refers to a wireless communication channel.

In this embodiment, a plurality of point-to-point links is used to transmit data to the terminals. This embodiment thus allows to exploit techniques called coordinated multi-point techniques, more commonly designated by COMP (Coordinated Multi-Point). By thus exploiting the spatial domain of the communication channel between the aerial or spatial devices and the terminal, this embodiment allows to benefit from the respective advantages of the spatial diversity or spatial multiplexing schemes. More particularly, the spatial diversity techniques consist in sending or receiving redundant information streams in parallel on several spatial paths in order to increase the reliability and the range of the communications; and the spatial multiplexing techniques consist in sending or receiving independent information streams in parallel on several spatial paths in order to increase the rate. Consequently, this embodiment allows to improve the communication performance in terms of coverage, rate and reliability.

According to one embodiment, the first device sends first data to said at least one terminal by using a time-frequency resource different from a time-frequency resource used by said at least one second device to transmit the second data to said at least one terminal.

This embodiment allows to implement frequency and/or time multiplexing techniques and thus allows to increase the communication rate. Indeed, in this embodiment, the first device benefits, thanks to the cooperation of the second device, from additional frequency and/or time resources to transmit data to said at least one terminal.

According to one embodiment, the first and second devices belong to the same constellation.

Thus, in this embodiment, the first and second devices are exploited for example by the same aircraft or satellite operator. In this embodiment, the first and second devices can be configured to communicate with the same ground station. In particular, the first device receives, from this ground station, the first data and/or the second data. However, it can also be envisaged within the framework of the invention that the first and second data are generated by the first device, for example by providing data from a cache embedded in the first device.

This embodiment allows to implement cooperation between aerial or spatial devices of the same constellation in a simple and dynamic manner to improve the communication performance of an aircraft or satellite communication system (e.g. a satellite access network). Furthermore, as mentioned above, the proposed method allows to implement cooperation with low-complexity architecture, and requiring only limited signaling between the ground station and the aerial or spatial devices.

According to one embodiment, the first device and said at least one second device belong to different constellations.

In this embodiment, the first and second devices are typically exploited by distinct operators and configured to communicate with distinct ground stations, the first satellite being able to receive, from the ground station with which it is configured to communicate, the first data and/or the second data.

This embodiment allows to implement cooperation between satellites of different constellations in a simple and dynamic manner with low complexity architecture.

According to one embodiment, the first device receives information, for example information relating to a power level received by said at least one terminal, said cooperation criterion being determined by the first device based on this information. In particular, this information can be sent to the first device by a terminal (e.g. said at least one terminal in question), or by a ground station, or by the cooperation entity. When the cooperation is triggered by the terminal emitting the information, a cost induced by the cooperation can be directly or indirectly billed to the terminal.

No limitation is attached to the nature of the information relating to a received power level. It can particularly take the form of a request to increase the received power, a received power level, or an indication that the received power level is below a given threshold.

This embodiment allows to initiate cooperation based on the power level of the signal received by the terminals. As an illustration, if the power received by the terminals does not allow implementing communications with the required specifications, for example in terms of rate and/or reliability, then the first device initiates cooperation with the second device to increase the power received by the terminals and/or to increase the time-frequency resources used to communicate with the terminals.

According to one embodiment, the first device sends, to a tracking entity, one or more usage proofs indicating resources used by the first device and/or said at least one second device to communicate with said at least one terminal.

This embodiment allows to achieve reliable and accurate traceability of the resources used by a communication system implementing a cooperation between aerial or spatial devices (for example aircrafts or satellites) to communicate data to a terminal. Indeed, the proposed method allows an aerial or spatial device to dynamically inform a tracking entity of the resources used. It is thus possible to track the resources used by several aerial or spatial devices to communicate data to terminals.

According to another aspect of the invention, a method implemented by a cooperation entity to communicate with a first aerial or spatial device is proposed, the method comprising:
determining information relating to resources of at least one second aerial or spatial device that can be used to transmit data to at least one terminal;
sending said information to the first device.

The proposed method implemented by the cooperation entity has the advantages described above in relation to the proposed method implemented by an aerial or spatial device.

According to one embodiment, said information relating to the resources of said at least one second device that can be used is determined from at least one target data transmission rate and from at least one outage probability defined for at least one communication service implemented by the second device.

By “target rate”, reference is made here to a data transmission rate targeted or to be achieved, for example to implement a communication service (i.e. a function) with a certain quality of service. And, by “outage probability”, reference is made here, for a given target rate, to a probability that a communication system is not able to deliver this target rate in a given geographical area, for example due to the variable capacity of the channel.

This embodiment allows not to penalize the implementation of a communication service provided by the second device with a certain quality of service. For example, if the second device only exploits part of its resources to implement the service in accordance with the specifications (i.e. target rate of the user equipment covered by the second satellite and benefiting from this service and outage probability of this user equipment), then the remaining resources of the second device are determined as being able to be used for cooperation with other aerial or spatial devices.

According to one embodiment, the proposed method comprises one or more iterations of an update of said information relating to the resources of said at least one second device that can be used from at least one adjusted rate, said at least one adjusted rate being obtained from said at least one target rate and a coefficient.

This embodiment allows to determine the resources of the second device that can be used for cooperation while maintaining a rate close to the target rate for a maximum of simultaneous connections. Thus, this embodiment allows to guarantee the availability of a minimum of resources of the second device to implement cooperation with other aerial or spatial devices.

According to one embodiment, said information relating to the resources of said at least one second device that can be used is determined from a plurality of target rates and a plurality of outage probabilities. For example, the target rates and the outage probabilities relate to a plurality of communication services implemented by the communication system.

The advantage of this embodiment is to guarantee that the communication services are implemented by the communication system in accordance with the specifications (i.e. the defined qualities of service).

According to one embodiment, said information relating to the resources of said at least one second device that can be used is determined from a statistic of the communication channel between said at least one second device and said at least one terminal for one or more beams emitted by said at least one second satellite.

By “a statistic of a communication channel”, reference is made here to a parameter of a statistical model of the communication channel. For example, the proposed method can exploit a standard deviation σ, used as a parameter of a channel model for describing shadowing phenomena.

This embodiment allows to statistically describe the phenomena of propagation of the signals between the aerial or spatial devices and the terminals. Among others, multipath propagation, shadowing by obstacles, weather conditions (e.g. precipitation) can result in a variable channel capacity. Consequently, this embodiment allows to take into account the variability of the power level received by the terminals to determine the free resources for the cooperation.

In one embodiment, the method implemented by the cooperation entity comprises:
sending, to the first device (SAT_X), data (DATA_T2) to be transmitted to said at least one terminal (UE), these data (DATA_T2) being transmitted to said at least one terminal (UE) via said at least one second device (SAT_Y); then;
sending, to a third aerial or spatial device (SAT_Z), data (DATA_T3) to be transmitted to said at least one terminal (UE).

In this embodiment, the inter-satellite cooperation allows to exploit the second aerial or spatial device as a relay during a transfer of the control of the terminal from the first aerial or spatial device to the third aerial or spatial device. This embodiment allows the first device to benefit from the resources of the second device to transmit data to the terminal, until the terminal passes under the control of the third aerial or spatial device. This embodiment thus allows in particular to artificially enlarge the coverage area of the communication system and to ensure continuity of service for the terminals. This control transfer allows the implementation of a data roaming mechanism and be qualified as long handover when this roaming involves another mobile service operator. According to another aspect of the invention, an aerial or spatial device, called first device, adapted to transmit data to at least one terminal is proposed, said first device comprises:
a receiving module configured to receive, from a cooperation entity, information relating to resources of at least one second aerial or spatial device that can be used to transmit data to said at least one terminal;
a sending module configured, if a cooperation criterion is verified, to trigger a cooperation with said at least second device as a function of said information to transmit data to said at least one terminal, said cooperation comprising sending, by the sending module, to said at least one second device, data called second data, to be transmitted to said at least one terminal.

The proposed aerial or spatial device has the advantages described above in relation to the proposed method implemented by an aerial or spatial device.

According to one embodiment, said first device comprises a determination module configured to determine a cooperation criterion.

According to one aspect of the invention, a cooperation entity adapted to communicate with a first aerial or spatial device is proposed, the cooperation entity comprising:
a determination module configured to determine information relating to resources of at least one second aerial or spatial device that can be used to transmit data to at least one terminal;
a sending module configured to send said information to the first device.

According to one embodiment, the cooperation entity is comprised in a ground station.

According to one aspect of the invention, a communication system is proposed comprising:
a first aerial or spatial device in accordance with the invention; and
at least one second aerial or spatial device comprising a receiving module configured to receive, from the first device, second data and a sending module configured to send the second data to at least one terminal.

The characteristics and advantages of the methods in accordance with the present invention described above also apply to the proposed communication system and vice versa.

According to one embodiment, the communication system comprises:
a cooperation entity in accordance with the invention; and/or
at least one terminal comprising a receiving module configured to receive data from said at least one second device.

According to one aspect of the invention, a computer program is proposed including instructions for the implementation of the steps of a method in accordance with the invention, when the computer program is executed by at least one processor or one computer.

The computer program can be formed of one or more sub-parts stored in the same memory or in distinct memories. The program can use any programming language, and be in the form of source code, object code, or intermediate code between source code and object code, such as in a partially compiled form, or in any other desirable form.

According to one aspect of the invention, a computer-readable information medium comprising a computer program in accordance with the invention is proposed.

The information medium can be any entity or device capable of storing the program. For example, the medium can include a storage means, such as a non-volatile memory or ROM, for example a CD-ROM or a microelectronic circuit ROM, or a magnetic recording means, for example a floppy disk or a hard disk. On the other hand, the storage medium can be a transmissible medium such as an electrical or optical signal, which can be conveyed via an electrical or optical cable, by radio or by a telecommunications network or by a computer network or by other means. The program according to the invention can in particular be downloaded from a computer network. Alternatively, the information medium can be an integrated circuit in which the program is incorporated, the circuit being adapted to execute or to be used in the execution of the method in question.

### BRIEF DESCRIPTION OF THE DRAWINGS

Other characteristics and advantages of the present invention will emerge from the description provided below of embodiments of the invention. These embodiments are given for illustrative purposes and are not limiting. The description provided below is illustrated by the attached drawings:

FIG. 1 schematically represents a communication system according to one embodiment of the invention;

FIG. 2 schematically represents a communication system according to one embodiment of the invention;

FIG. 3 schematically represents a communication system according to one embodiment of the invention;

FIG. 4 schematically represents a communication system according to one embodiment of the invention;

FIG. 5 represents, in the form of a flowchart, steps of a communication method according to one embodiment of the invention;

FIG. 6 schematically represents one example of information obtained and processed by a communication system according to one embodiment of the invention;

FIG. 7 represents, in the form of a flowchart, steps of a communication method according to one embodiment of the invention;

FIG. 8 represents, in the form of a flowchart, steps of a communication method according to one embodiment of the invention;

FIG. 9 schematically represents one example of software and hardware architecture of a communication system according to one embodiment of the invention;

FIG. 10 schematically represents one example of functional architecture of a communication system according to one embodiment of the invention.

### DESCRIPTION OF THE EMBODIMENTS

The present invention concerns a method implemented by an aerial or spatial device to communicate with at least one terminal and a method implemented by a cooperation entity to communicate with an aerial or spatial device, as well as an aerial or spatial device, a cooperation entity, a system, a computer program and an information medium associated therewith.

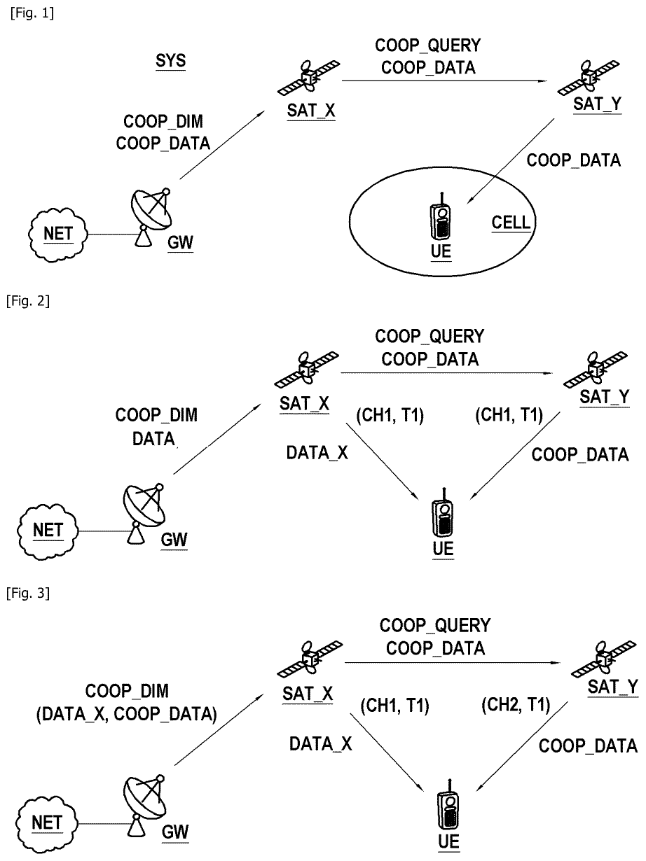

FIG. 1 schematically represents a communication system according to one embodiment of the invention.

As illustrated in FIG. 1, the satellite communication system SYS comprises according to one embodiment: a ground station GW; a first satellite SAT_X; a second satellite SAT_Y and at least one terminal UE. The communication system implements one or more satellite communication services. In particular, the satellites SAT_X and SAT_Y can implement the same communication service or different communication services. The communication system transmits data from a communication network NET to said at least one terminal UE. To do so, the communication system implements an inter-satellite cooperation, in other words several satellites SAT_X and SAT_Y of the communication system collaborate with each other to communicate data to said at least one terminal UE.

According to this embodiment, the inter-satellite cooperation is of the relay type, the second satellite SAT_Y being exploited as a relay (i.e. repeater) between the first satellite SAT_X and said at least one terminal UE. In other words, the first satellite SAT_X transmits data to said at least one terminal UE via the second satellite SAT_Y. This embodiment allows the first satellite SAT_X to benefit from the resources of the second satellite SAT_Y to transmit data to the terminal UE. This embodiment for example allows to artificially enlarge the coverage area of the communication system, the first satellite SAT_X can rely on the coverage area of the second satellite SAT_Y to communicate with terminals UE. Furthermore, this embodiment allows to increase the power of the signal received by said at least one terminal UE, typically by selecting a relay satellite SAT_Y closer to said at least one terminal UE, which thus allows to improve the reliability and/or the rate of the communications. Said at least one terminal UE is thus located in the cell CELL of the second satellite SAT_Y.

According to this embodiment, the ground station GW is configured to communicate with the communication network NET. The ground station GW sends, to the first satellite SAT_X, information COOP_DIM relating to available resources of the second satellite SAT_Y that can be used to transmit data in the cell CELL, and thus be used within the framework of a cooperation with the first satellite. According to one exemplary implementation, the information COOP_DIM corresponds to a number of available frequency channels of the second satellite SAT_Y. The ground station GW further sends, to the first satellite SAT_X, data COOP_DATA to be communicated to said at least one terminal UE.

According to this embodiment, the first satellite SAT_X receives, from the ground station GW, the information COOP_DIM and the data COOP_DATA to be communicated to the terminal UE, independently or concomitantly.

Based on the information relating to the available resources COOP_DIM, the first satellite SAT_X sends, to the second satellite SAT_Y, a cooperation query COOP_QUERY to transmit data to said at least one terminal UE and then the data COOP_DATA to be transmitted to said at least one terminal UE. Hereinafter, the cooperation query COOP_QUERY is also called query to transmit data to said at least one terminal UE. It should be noted that the sending of the cooperation query COOP_QUERY is not performed synchronously with the receipt of the information relating to the available resources COOP_DIM. Indeed, the first satellite SAT_X sends a cooperation query COOP_QUERY if it determines particularly that the data transmission requires it, which is detailed with reference to FIG. 5.

According to one exemplary implementation, the information COOP_DIM indicates that the second satellite SAT_Y has a plurality of free channels that can be used to transmit data in the cell CELL. According to one embodiment, the information COOP_DIM indicates a number of frequency channels available for a given outage probability. Based on this information COOP_DIM, the first satellite SAT_X requests the second satellite SAT_Y to communicate the data COOP_DATA to said at least one terminal UE with a view to adapting the reliability and/or the communication rate. In particular, this involves maintaining an acceptable level of the communication service.

According to this embodiment, the second satellite SAT_Y receives, from the first satellite SAT_X, the cooperation query COOP_QUERY and the data COOP_DATA to be transmitted to said at least one terminal UE. Following this receipt, the second satellite SAT_Y sends the data COOP_DATA to said at least one terminal UE.

According to this embodiment, said at least one terminal UE receives, from the second satellite SAT_Y, the data COOP_DATA to be transmitted to the terminal UE.

The invention thus allows to implement inter-satellite cooperation initiated by the satellites themselves autonomously. As a result, the invention requires only a few exchanges between the ground station and the satellites to implement cooperation, which particularly allows to deploy a satellite communication system with a limited number of ground stations.

By way of illustration, the present invention can be exploited to implement mobile telephone networks based on radio access technologies of the OFDMA (Orthogonal Frequency Division Multiple Access) type.

The autonomy of the satellites with regard to the implementation of the cooperation is enabled by the sending of the information relating to the available resources COOP_DIM and their updates thereto. Indeed, following the receipt of the information COOP_DIM, the satellites have the information required to initiate a cooperation if necessary. In addition, it should be emphasized that the sending of the information relating to the available resources COOP_DIM can be performed asynchronously, i.e. without time constraints, compared to the sending of the data COOP_DATA to be transmitted to the terminal UE. This embodiment allows to reduce the time constraints on the communication system to implement an inter-satellite cooperation. This embodiment allows to use inter-satellite cooperation opportunistically and dynamically, and allows to respond to rapid rate variations.

The following example illustrates the latter embodiment, and is not limiting. The information COOP_DIM relating to the available resources is sent to the first satellite SAT_X and indicates to it that the second satellite SAT_Y has, for a given period of time (e.g. one hour, one day, etc.), resources usable for a cooperation. Thus, at any moment during this period of time, the first satellite SAT_X can initiate a cooperation with the second satellite SAT_Y. Typically, the data COOP_DATA to be communicated to a terminal UE are application data with constraints on the transmission time between the emitter of these data and the terminal, e.g. data of a telephone communication or of a web browser session.

No limitation is attached to the nature of the communication network NET, which can be a mobile telephone network (2G, 3G, 4G, 5G, 6G, etc.), an Internet-type computer network, or any other network (owner, etc.) that can be envisaged. The communication interface between the network NET and the ground station GW can be wired or non-wired, and can implement any protocol known to those skilled in the art.

No limitation is attached to the nature of the communication interfaces between the ground station GW and the first satellite SAT_X or between the first satellite SAT_X and the second satellite SAT_Y. In particular, according to one embodiment, one or more intermediate satellites are used to relay the data from the ground station GW to the first satellite SAT_X and/or from the first satellite SAT_X to the second satellite SAT_Y.

In accordance with the invention, the satellites of the communication system SYS can describe geostationary, medium or low Earth orbits. As a result, the coverage areas of the different satellites can be stationary or moving over time. Moreover, it is important to note that the satellites of the communication system can be exploited by the same satellite operator or by different satellite operators. In the latter case, the communication system allows to implement cooperation between several mobile and/or satellite operators.

The terminals UE can be of the mobile telephone type, for example a Smartphone, or a tablet, or a computer or any other type of communicating device such as IoT devices.

FIG. 2 schematically represents a communication system according to one embodiment of the invention.

According to one embodiment, the inter-satellite cooperation implemented by the communication system is of the CoMP (Coordinated Multi-Point) type. According to this embodiment, the first satellite SAT_X and the second satellite SAT_Y are exploited to transmit data to said at least one terminal UE in a coordinated manner, by using the same time-frequency resources. This embodiment allows to exploit the spatial domain of the communication channel to improve the communication performance in terms of coverage, rate and/or reliability.

As an example, according to the embodiment illustrated in FIG. 2, the first satellite SAT_X and the second satellite SAT_Y send data DATA_X and COOP_DATA to said at least one terminal UE by using the same time-frequency block (CH1, T1). The notation (CH1, T1) is used here to refer to a pair consisting of a frequency channel CH1 and of a transmission time interval T1. According to this embodiment, the satellites SAT_X and SAT_Y coordinate their transmissions so that, at the level of said at least one terminal UE, the receipt of the data DATA_X from the first satellite SAT_X is synchronized with the receipt of the data COOP_DATA from the second satellite SAT_Y. According to this embodiment, the cooperation query COOP_QUERY comprises control data necessary for the coordination of the satellites SAT_X and SAT_Y, for example the emission offset times determined from the positions of the satellites and the cell.

A terminal UE can have one or more receiving antennas. According to one embodiment, the terminal UE has a single antenna such that the communication system thus describes a MISO (Multiple-Input Single-Output) system. According to another embodiment, a terminal UE has a plurality of antennas such that the communication system describes a MIMO (Multiple-Input Multiple-Output) system.

No limitation is attached to the nature of the data DATA_X and COOP_DATA respectively sent by the first satellite SAT_X and the second satellite SAT_Y which can be identical or different. It should be noted that, according to one embodiment, the data COOP_DATA and DATA_X are comprised in the data DATA.

According to a first exemplary embodiment, the data DATA_X and COOP_DATA are identical, the CoMP type inter-satellite cooperation being exploited to increase the power of the received signal.

According to a second exemplary embodiment, the data DATA_X and COOP_DATA are different. In this example, the COMP type inter-satellite cooperation is exploited to implement spatial multiplexing by sending independent data DATA_X and COOP_DATA in parallel on several spatial paths, which allows to increase the transmission rate.

According to a third example, the data DATA_X and COOP_DATA are different. In this example, the COMP type inter-satellite cooperation exploits the spatial diversity of the channel by sending redundant data DATA_X and COOP_DATA in parallel on several spatial paths in order to increase the reliability and the range of the communications.

FIG. 3 schematically represents a communication system according to one embodiment of the invention.

According to this embodiment, the inter-satellite cooperation implemented by the communication system is of the carrier aggregation type. In this embodiment, the first satellite SAT_X and the second satellite SAT_Y are exploited to simultaneously send data to said at least one terminal UE by using different frequency resources. This embodiment allows to implement frequency multiplexing, and thus improve the transmission rate.

As an example, according to the embodiment illustrated in FIG. 3, the first satellite SAT_X transmits data DATA_X to said at least one terminal UE by using a time-frequency block (CH1, T1); and the second satellite SAT_Y transmits data COOP_DATA to said at least one terminal UE by using a different time-frequency block (CH2, T1). Obviously, no limitation is attached to the nature of the data DATA_X and COOP_DATA, which can be identical or different.

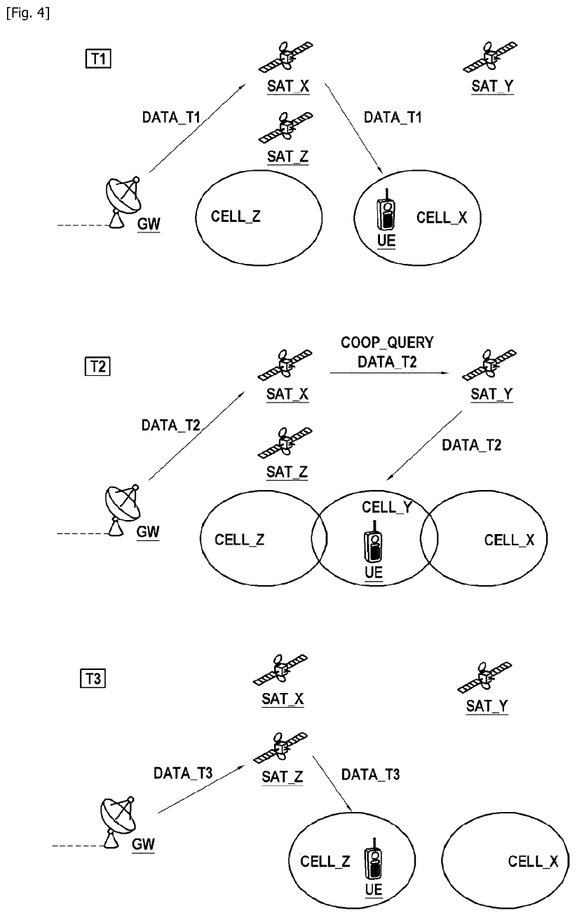

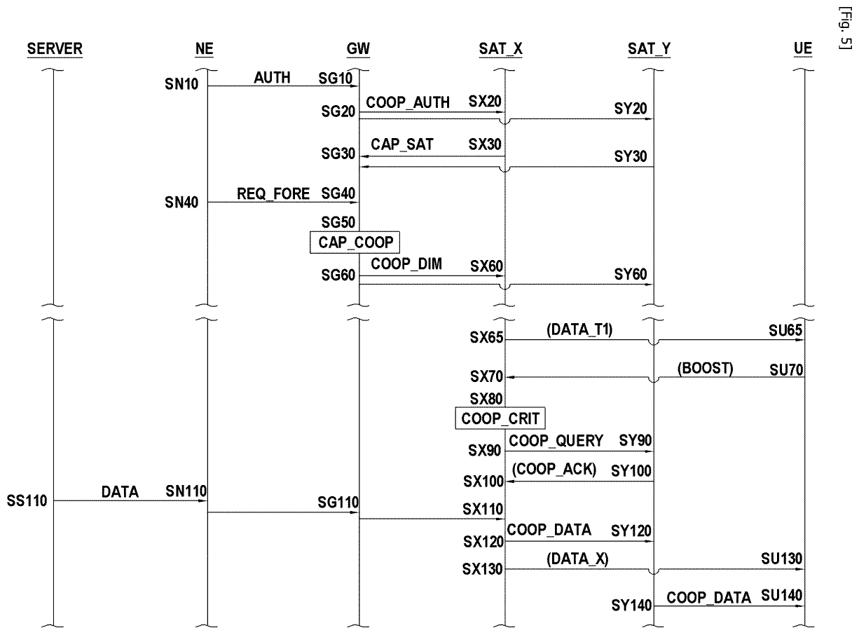

FIG. 4 schematically represents a communication system according to one embodiment of the invention.

According to this embodiment illustrated in FIG. 4, the inter-satellite cooperation consists in exploiting the second satellite SAT_Y as a relay to perform a control transfer of said at least one terminal from the first satellite SAT_X to a third satellite SAT_Z. In this embodiment, it is assumed that the satellites SAT_X and SAT_Z belong to the same constellation, and that the satellite SAT_Y belongs to a constellation different from the constellation to which the satellites SAT_X and SAT_Z belong. This embodiment allows the first satellite SAT_X to benefit from the resources of the second satellite SAT_Y to transmit data to the terminal UE. This embodiment allows for example to artificially enlarge the coverage area of the communication system and to ensure continuity of service for the terminals. In particular, the control transfer is qualified as long handover in that it includes data roaming via another mobile service operator MNO.

FIG. 4 illustrates one embodiment in which a transfer of the control comprises the following steps:
during a time interval T1, the first satellite SAT_X transmits data DATA_T1 to said at least one terminal UE;
during a time interval T2, the second satellite SAT_Y transmits data DATA_T2 to said at least one terminal UE;
during a time interval T3, the third satellite SAT_Z transmits data DATA_T3 to said at least one terminal UE.

The long handover example illustrated in FIG. 4 is described here. During the time interval T1, the first satellite SAT_X transmits data DATA_T1 to a terminal UE. In this example, the satellite SAT_X moves away from the terminal UE, such that the terminal UE is likely to be shortly located outside the coverage area CELL_X of the satellite SAT_X. For this reason, a handover must be initiated to switch the terminal UE to a third satellite SAT_Z.

However, during the time interval T2, the terminal UE is not yet inside the coverage area CELL_Z of the third satellite SAT_Z. Consequently, the first satellite SAT_X sends a cooperation query COOP_QUERY to the second satellite SAT_Y, whose coverage area CELL_Y comprises the terminal UE. The first satellite SAT_X also sends, to the second satellite SAT_Y, the data DATA_T2 to be communicated to the terminal. Following this, the second satellite SAT_Y sends the data DATA_T2 to the terminal UE.

During the time interval T3, the coverage area CELL_Z of the third satellite SAT_Z now comprises the terminal UE and the latter switches to the third satellite SAT_Z. Following this, the third satellite SAT_Z sends data DATA_T3 to said at least one terminal UE.

According to one embodiment, the switchover from the terminal UE to the third satellite SAT_Z is performed as follows: the ground station GW sends, to the first satellite SAT_X, the data DATA_T2 to be transmitted to said at least one terminal UE, these data DATA_T2 being transmitted to the terminal UE via the second satellite SAT_Y; then, the ground station GW sends, to the third satellite SAT_Z, the data DATA_T3 to be transmitted to the terminal UE. Thus, the ground station GW switches the data stream to the terminal UE from the first satellite SAT_X to the third satellite SAT_Z.

As an example, it is considered that the first satellite SAT_X and the third satellite SAT_Z are exploited by the same operator SNO_XZ, while the second satellite SAT_Y is exploited by another operator SNO_Y. Then, this embodiment allows the operator SNO_XZ to provide the terminals UE with continuity of service, even though the union of the coverage areas of its satellites CELL_X and CELL_Z is not continuous. This continuity of service is enabled by the cooperation with the second satellite SAT_Y without using the terrestrial network core of the operator SNO_Y.

FIG. 5 represents, in the form of a flowchart, steps of a communication method according to one embodiment of the invention.

As illustrated in FIG. 5, the communication system comprises according to one embodiment: a server SERVER; a network entity NE; a ground station GW; a first satellite SAT_X; a second satellite SAT_Y; and at least one terminal UE.

FIG. 5 describes steps implemented by the different elements of the communication system according to one embodiment and illustrates over time data exchanges between these elements. The following reference signs allow, for each of the steps of the method, to identify the element implementing this step: The references starting with SS are used for the steps implemented by the server SERVER; SN for the network entity NE; SG for the ground station GW; SX for the first satellite SAT_X; SY for the second satellite SAT_Y; SU for said at least one terminal UE.

According to this embodiment, the server SERVER is an application server emitting data DATA to said at least one terminal UE. For example, the server SERVER can be a mobile telephone server, or a web server. According to this embodiment, the network entity NE is exploited by a mobile operator called MNO (Mobile Network Operator), while the ground station GW is exploited by a satellite operator called SNO (Satellite Network Operator). According to another embodiment, for example within a context of edge application functions, the server SERVER is an application server emitting the data DATA to said at least one terminal UE hosted in SAT_X.

During a step SG10, the ground station GW receives, from the network entity NE, resource delegation authorizations AUTH (sent during a step SN10). The authorizations AUTH are for example sent by one or more mobile operators MNO and specify the spectra and the spots that can be exploited by the satellites to cooperate.

During a step SG20, the ground station GW sends cooperation authorizations COOP_AUTH (received during steps SX20 and SY20) to the satellites SAT_X and SAT_Y. As an illustration, a cooperation authorization COOP_AUTH authorizes the second satellite SAT_Y to cooperate with the first satellite SAT_X.

During a step SG30, the ground station GW receives, from the satellites SAT_X and SAT_Y, information CAP_SAT relating to the resources of the satellites SAT_X and SAT_Y (sent during steps SX30 and SY30). For example, for a satellite SAT_X, the information CAP_SAT can specify the available frequency channels to transmit data in different cells.

During a step SG40, the ground station GW receives, from the entity NE, information REQ_FORE relating to specifications of the communication system (sent during a step SN40). For example, the information REQ_FORE is emitted by a mobile operator MNO and corresponds to forecasts of needs to implement a communication service, in terms of target rate, outage probability, and number of connections required over a period of time.

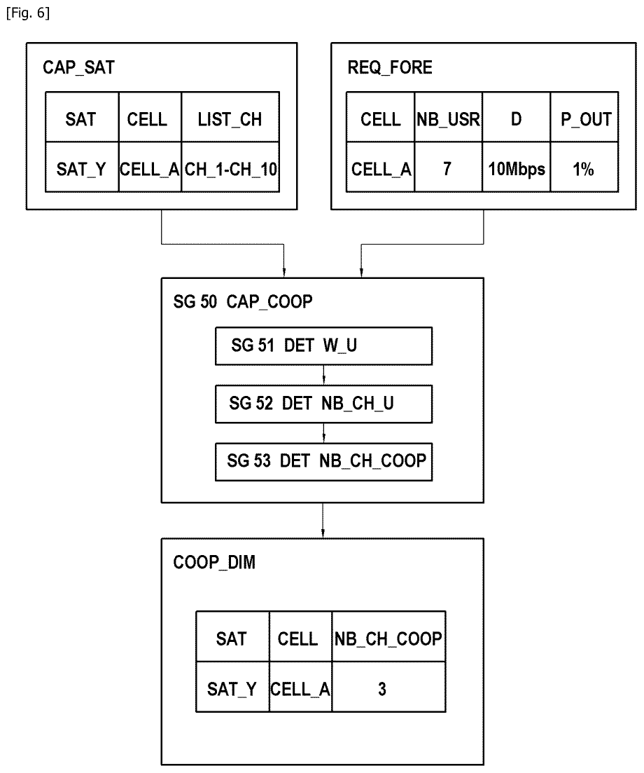

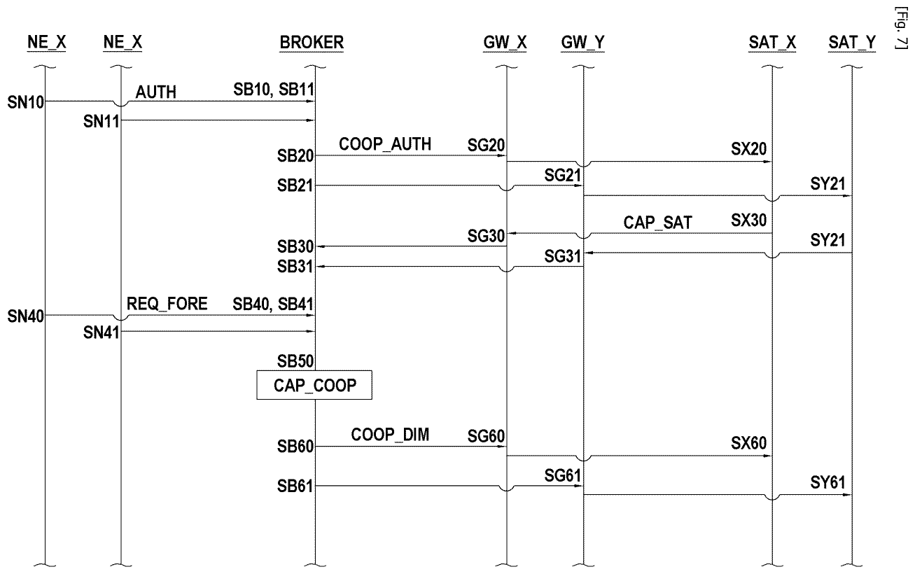

During a step SG50, the ground station GW determines information COOP_DIM relating to the resources of the satellites that can be used for a cooperation. According to one embodiment, the information COOP_DIM corresponds to the numbers of free channels of the satellites, these free channels being able to be used for a cooperation. The determination of the information COOP_DIM by a module CAP_COOP of the ground station GW is detailed below with reference to FIG. 6.

During a step SG60, the ground station GW sends, to the satellites SAT_X and SAT_Y, the information COOP_DIM on the number of channels or more generally available resources (received during steps SX60 and SY60). For example, the information COOP_DIM is sent to the satellite SAT_X and indicates to it that the satellite SAT_Y has a plurality of channels that can be used to transmit data in the cell CELL.

According to one particular embodiment, the proposed method comprises several iterations of at least one of the steps SG40, SG50 and S60. Thus, the method comprises, according to this embodiment, an update of the information COOP_DIM. This embodiment allows to regularly update the information COOP_DIM, for example according to new forecasts of needs REQ_FORE.

During a step SX65, according to one particular embodiment, the first satellite SAT_X sends data DATA_T1 (received during a step SU65) to said at least one terminal UE.

During a step SX70, according to one particular embodiment, the first satellite SAT_X receives, from said at least one terminal UE, information BOOST relating to a power level received by said terminal UE (sent during a step SU70). The information BOOST can particularly include a request to increase the power of the received signal, a power level of the received signal, or indicate that the power of the received signal is below a threshold, etc. For example, the information BOOST is a signal-to-interference-plus-noise ratio, more commonly designated by SINR, at the level of the terminal UE for a signal received from the first satellite SAT_X.

During a step SX80, the first satellite SAT_X determines a cooperation criterion COOP_CRIT. The criterion COOP_CRIT conditions the initialization of a cooperation by the first satellite SAT_X with the second satellite. In particular, the first satellite SAT_X thus determines in step SX80 whether a cooperation is necessary.

A first exemplary implementation of step SX80 is described here. Following the receipt of the information BOOST in step SX70, the first satellite SAT_X determines that a cooperation is necessary and, based on the information relating to the available resources COOP_DIM, sends a cooperation query COOP_QUERY to the second satellite SAT_Y.

According to a second example, the first satellite SAT_X encounters a peak load over a given period of time. In this example, the first satellite SAT_X does not have sufficient frequency resources to communicate all of the data to the terminals, and determines that a cooperation is necessary.

More generally, the criterion COOP_CRIT can be determined by the first satellite SAT_X based on at least one of the following information: a link budget between the first satellite SAT_X and the cell CELL; the trajectories of the satellites SAT_X and SAT_Y; the geographical coordinates defining the cell CELL.

During a step SX90, as a function of the information COOP_DIM, the first satellite SAT_X sends a cooperation query COOP_QUERY (received during a step SY90) to the second satellite SAT_Y. The cooperation query COOP_QUERY is a query to transmit data to said at least one terminal UE. According to one embodiment, the cooperation query COOP_QUERY comprises control data, for example one or more of the following information: channels to be used, cells, emission power levels, emission durations, and synchronization information. In particular, the synchronization information allows the satellites SAT_X and SAT_Y to coordinate their emissions so that the signals emitted by the satellites are synchronously received by a receiver.

During a step SX100, according to one particular embodiment, the first satellite SAT_X receives, from the second satellite SAT_Y, a response COOP_ACK to the cooperation query COOP_QUERY (sent during a step SY100). According to one embodiment, the response COOP_ACK comprises information COOP_START indicating that the satellite SAT_Y is available to cooperate, or information COOP_STOP indicating a downtime.

During a step SX110, the first satellite SAT_X receives data DATA from the ground station GW (sent by the server SERVER, the network entity NE and the ground station GW respectively during steps SS110, SN110, and SG110). The data DATA are for example emitted by the server SERVER comprised in the computer network NET.

During a step SX120, the first satellite SAT_X sends, to the second satellite SAT_Y, data COOP_DATA to be transmitted to said at least one terminal UE (received during a step SY120).

During a step SX130, according to one embodiment, the first satellite SAT_X sends data DATA_X (received during a step SU130) to said at least one terminal UE. The first satellite transmits the data DATA_X for example by using a time-frequency block (CH1, T1). The data DATA_X can be different from or identical to the data COOP_DATA.

If step SX130 is not implemented, then the inter-satellite cooperation is of the relay type as previously described with reference to FIG. 1. Otherwise, if step SX130 is implemented, then the inter-satellite cooperation is of the CoMP or carrier aggregation type as previously described with reference to FIGS. 2 and 3.

During a step SY140, the second satellite SAT_Y sends the data COOP_DATA (received during a step SU140) to said at least one terminal UE. According to one embodiment, the second satellite SAT_Y sends the data COOP_DATA by using a time-frequency block (CH1, T1) identical to the time-frequency block used by the first satellite SAT_X to send the data DATA_X. According to another embodiment, the second satellite SAT_Y sends the data COOP_DATA by using a different time-frequency block (CH2, T1).

If, during step SY140, the second satellite SAT_Y uses a time-frequency block (CH1, T1) identical to the time-frequency block used by the first satellite SAT_X, then the inter-satellite cooperation is of the COMP type as previously described with reference to FIG. 2. If, during step SY140, the second satellite SAT_Y uses a time-frequency block (CH2, T1) different from the time-frequency block used by the first satellite SAT_X, then the inter-satellite cooperation is of the carrier aggregation type as previously described with reference to FIG. 3.

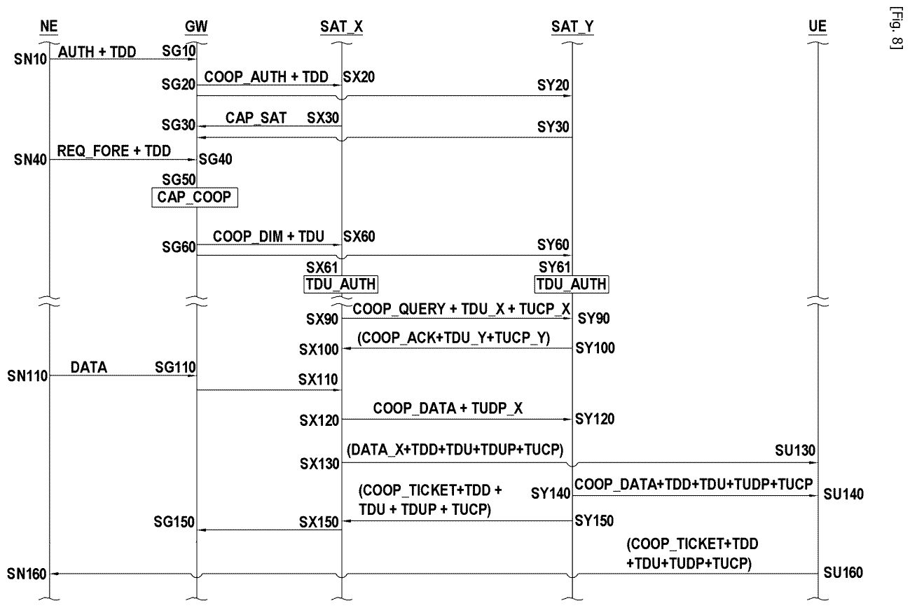

In the embodiments described with reference to FIG. 5, the cooperation entity in accordance with the invention-determining the information COOP_DIM—is comprised in the ground station GW. However, within the framework of the invention, other embodiments could be envisaged in which the cooperation entity is comprised in any ground station, or a satellite management entity, or a geostationary satellite, etc. For example, one embodiment is described with reference to FIG. 7 in which the cooperation entity is common to several operators MNO and to several operators SNO.

FIG. 6 schematically represents one example of information obtained and processed by a communication system according to one embodiment of the invention. In particular, FIG. 6 allows to illustrate the determination by the module CAP_COOP of the information COOP_DIM relating to the available resources, then used by the satellites SAT_X and SAT_Y to implement inter-satellite cooperation.

According to one embodiment, the communication system processes the following information: CAP_SAT relating to the resources of the satellites; REQ_FORE relating to the specifications of the communication system; and COOP_DIM relating to the resources of the satellites that can be used for a cooperation.

The information CAP_SAT relates to the resources of one or more satellites to transmit data in one or more cells. According to one embodiment, for given satellite SAT and cell CELL, the information CAP_SAT comprises one or more frequency bands LIST_CH exploitable by the satellite to transmit data in the cell. For example, as illustrated in FIG. 6, the satellite SAT_Y can exploit the channels CH_1 to CH_10 to transmit, within the framework of one or more services provided by this satellite SAT_Y, data to user equipment, such as for example terminals, located in the cell CELL_A.

The information REQ_FORE relates to the specifications of the communication system. According to one embodiment illustrated in FIG. 6, for a given cell CELL, the information REQ_FORE comprises: a target communication rate D of this user equipment, an outage probability P_OUT of this equipment, and a number of connections NB_USR. Furthermore, the information REQ_FORE can comprise: signal power levels received by this equipment; frequency bands; geographical coordinates defining the cells. For example, the information REQ_FORE is emitted by one or more operators MNO and describes specifications necessary to implement communication services. According to this example, the information REQ_FORE corresponds to forecasts of needs of the operators MNO.

The information COOP_DIM relates to the resources of one or more satellites that can be used to transmit data in one or more cells. For given satellite SAT and cell CELL, the information COOP_DIM can indicate: a number of channels; a spectrum; one or more frequency bands, these resources of the satellite SAT being free and being able to be used to cooperate. For example, as illustrated in FIG. 6, the satellite SAT_Y has three free channels to cooperate by transmitting data in the cell CELL_A.

According to one embodiment illustrated in FIG. 6, the information COOP_DIM is determined by a module CAP_COOP of the ground station GW during a step SG50 based on the information CAP_SAT and REQ_FORE.

Here, a satellite SAT offering a communication service to equipment is considered. According to one embodiment, the information COOP_DIM for the satellite SAT is determined from a transmission rate D and from an outage probability P_OUT of this equipment relating to the service of the satellite SAT. The information COOP_DIM can also be determined from a statistic of the communication channel between the satellite and a terminal. As an indication, the statistic of the communication channel between the satellite and equipment used to determine the information COOP_DIM is a standard deviation σ, used as a parameter of a channel model for describing shadowing phenomena, as described below.

The determination of the information COOP_DIM by the module CAP_COOP comprises, according to one embodiment, at least one of the following steps.

During a step SG51, the module CAP_COOP determines, for the considered satellite SAT, a useful bandwidth W_U necessary to implement NB_USR connections with a rate D and an outage probability P_OUT between the satellite in question and equipment. The rate D, the probability P_OUT and the number of connections NBR_USR can correspond to the specifications required by the service of the satellite SAT.

During a step SG52, the module CAP_COOP determines, from the useful bandwidth W_U and from a channel bandwidth W_CH, a number of useful channels NB_CH_U to implement the service of the satellite SAT.

During a step SG53, the module CAP_COOP determines, from the number of useful channels NB_CH_U and from a total number of channels NB_CH_TOT, a number of free channels NB_CH_COOP. The channels called free channels are, a priori, not necessary for the implementation of the service of the satellite SAT. For this reason, the free channels can be used to implement an inter-satellite cooperation.

More particularly, in the embodiment described here, the module CAP_COOP exploits the following capacity formula during step SG51. For a spot of a satellite, the maximum capacity in number of simultaneous connections (i.e. NB_USR) is expressed as follows:

$$C = \frac{W}{D} \cdot {log}_{2} ( 1 + \frac{exp ( c )}{exp ( c ) ( {N}_{B} - 1 ) + {N}_{th}} ) \qquad [ Math . 1 ]$$

$$where$$

$$c = a {σ}^{′} \cdot {Q}^{- 1} ( 1 - {P}_{out} ) + {am}^{′} \qquad [ Math . 2 ]$$

$$and$$

$$Q ( u ) = \frac{1}{2} erfc ( \frac{u}{\sqrt{2}} ) \qquad [ Math . 3 ]$$

$$and$$

$${am}^{′} = log ( KP \cdot {\sum }_{j = 1}^{n} {d}_{j}^{- 2} exp ( \frac{{a}^{2} {σ}^{2}}{2} ) {( ( exp ( {a}^{2} {σ}^{2} ) - 1 ) F + 1 )}^{- \frac{1}{2}} ) \qquad [ Math . 4 ]$$

$$and$$

$${a}^{2} {σ}^{′2} = log ( ( exp ( {a}^{2} {σ}^{2} ) - 1 ) F + 1 ) + {a}^{2} {σ}^{2} \qquad [ Math . 5 ]$$

$$and$$

$$F = \frac{{\sum }_{j = 1}^{n} {d}_{j}^{- 4}}{{( {\sum }_{j = 1}^{n} {d}_{j}^{- 2} )}^{2}} \qquad [ Math . 6 ]$$

For this expression of the capacity, the following parameters are used: F, a form factor relating to the satellites of the communication system; n, the total number of satellites or satellite beams (i.e. spot); P, an emission power of the satellites; K, a propagation factor function of the emission frequency; W, a bandwidth; D, a transmission rate required for each connection; N_{B}, a number of interfering spots; σ, a standard deviation of the shadowing; Nₜₕ, thermal noise; dⱼ, a distance between the satellite j and the receiving equipment; Pₒᵤₜ, an outage probability; and a a constant for example equal to log

$$\frac{log ( 10 )}{10} ≃ 0.23 .$$

Thus, the module CAP_COOP determines the information COOP_DIM from all or part of the parameters mentioned above.

According to this embodiment, the capacity formula above is exploited by the module CAP_COOP to determine a useful bandwidth W_U (W in [Math. 1]) necessary to implement NB_USR connections (C in [Math. 1]) with a rate D (D in [Math. 1]) and an outage probability P_OUT (Pₒᵤₜ in [Math. 1]).

The other parameters of the formula above are parameters defined by the module CAP_COOP.

According to one embodiment, the module CAP_COOP achieves a plurality of iterations of the steps described above. According to one particular embodiment, at each iteration, the achievement module adjusts the rate D by a coefficient α and updates the information COOP_DIM. The adjusted rate aD, for example 95% of D, is qualified as a degraded rate. The consolidation loop thus implemented by the module CAP_COOP allows to take into account and optimize the resources of the constellations and the queries of the MNOs.

FIG. 7 represents, in the form of a flowchart, steps of a communication method according to one embodiment of the invention. In particular, this embodiment illustrates a communication system in which the satellites SAT_X and SAT_Y belong to different constellations. This embodiment can be combined with the embodiments previously described, particularly the embodiments described with reference to FIGS. 1 to 3. This embodiment thus allows to implement inter-satellite cooperation of the relay, CoMP or carrier aggregation type between satellites belonging to different constellations.

In comparison with FIG. 5, the communication system comprises according to the embodiment illustrated in FIG. 7: two network entities NE_X and NE_Y; a cooperation entity BROKER; two ground stations GW_X and GW_Y.

For example, this embodiment describes a cooperation between several mobile operators MNOs and several satellite operators SNOs. In this embodiment, the cooperation is implemented particularly by the entity BROKER, which can be common to several operators MNOs and several operators SNOs. The entity BROKER can be centralized or decentralized. In particular, the entity BROKER is configured to determine the information COOP_DIM relating to the resources of the satellites that can be used to cooperate.

During steps SB10 and SB11, the cooperation entity BROKER receives, from the network entities NE_X and NE_Y, the resource delegation authorizations AUTH (sent during steps SN10 and SN11). The authorizations AUTH are, for example, sent by one or more mobile operators MNOs and specify the spectra and the spots that can be exploited by the satellites to cooperate.

During steps SB20 and SB21, the cooperation entity BROKER sends, to the satellites SAT_X and SAT_Y via the ground stations GW_X and GW_Y, the cooperation authorizations COOP_AUTH (received by the ground stations GW_X and GW_Y during steps SG20 and SG21 and then received by the satellites SAT_X and SAT_Y during steps SX20 and SY21).

During steps SB30 and SB31, the cooperation entity BROKER receives, from the satellites SAT_X and SAT_Y via the ground stations GW_X and GW_Y, the information CAP_SAT (sent by the satellites SAT_X and SAT_Y during steps SX30 and SY31 and then by the ground stations GW_X and GW_Y during steps SG30 and SG31).

During steps SB40 and SB41, the cooperation entity BROKER receives the information REQ_FORE from the network entities NE_X and NE_Y (sent during steps SN40 and SN41).

During a step SB50, the cooperation entity BROKER determines the information COOP_DIM, this step being detailed below.

In the embodiment described herein, during steps SB60 and SB61, the cooperation entity BROKER sends the information COOP_DIM to the satellites SAT_X and SAT_Y via the ground stations GW_X and GW_Y (received by the ground stations GW_X and GW_Y during steps SG60 and SG61 and then received by the satellites SAT_X and SAT_Y during steps SX60 and SY61).

Based on the received information COOP_DIM and/or authorizations AUTH, the satellites SAT_X and SAT_Y will be able to set up inter-satellite cooperation.

In this embodiment, the operators MNO_X and MNO_Y can implement different communication services, and whose specifications are distinct. Thus, according to one embodiment, the information COOP_DIM is determined from a plurality of transmission rates D_X and D_Y and from a plurality of outage probabilities POUT_X and POUT_Y relating to a plurality of communication services implemented by the communication system SYS.

As an example, two communication services with rates D₁ and D₂ and outage probabilities Pₒᵤₜ_{₁} and Pₒᵤₜ_{₂} are considered. Then, in this case, the module CAP_COOP exploits an expression of the capacity of the communication system for a spot:

$$C = \frac{{α}_{1} W}{{D}_{1}} \cdot {log}_{2} ( \frac{exp ( {c}_{1} ) \cdot {N}_{B} + {N}_{th}}{{N}_{th} + ( {N}_{B} - 1 ) \cdot exp ( {c}_{1} )} ) + \frac{{α}_{2} W}{{D}_{2}} \cdot {log}_{2} ( \frac{exp ( {c}_{2} ) \cdot {N}_{B} + {N}_{th}}{{N}_{th} + ( {N}_{B} - 1 ) \cdot exp ( {c}_{2} )} ) \qquad [ Math . 7 ]$$

with α₁+β₂=1 and c₁, c₂ respectively function of Pₒᵤₜ_{₁}, Pₒᵤₜ_{₂} in accordance with the expression [Math. 2].

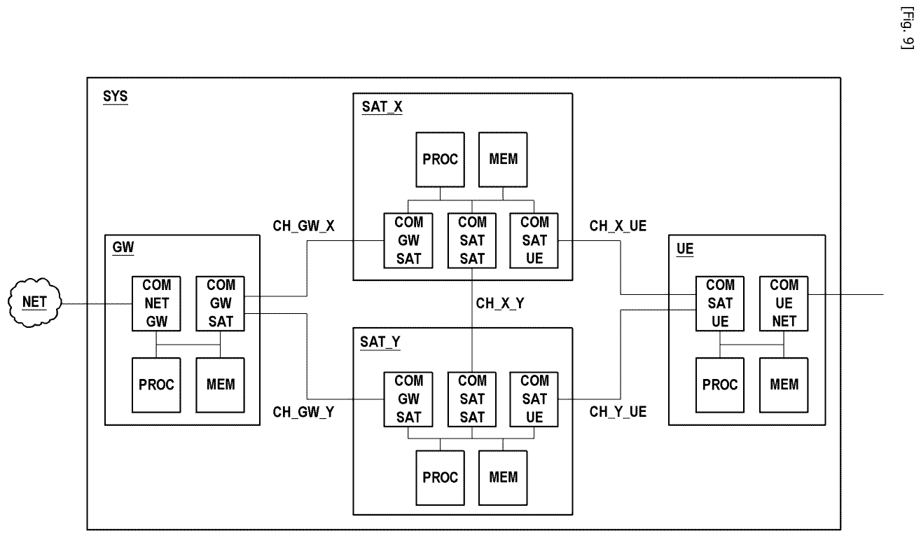

FIG. 8 represents, in the form of a flowchart, steps of a communication method according to one embodiment of the invention.

According to one embodiment illustrated in FIG. 8, the communication system implements a method for tracking a resource use to communicate with said at least one terminal UE. This embodiment particularly allows to achieve reliable and accurate traceability of the resources used during inter-satellite cooperation to communicate data to a terminal.

According to this embodiment, the communication system SYS comprises at least one resource use tracking entity. As an example, it is considered below that this tracking entity is comprised in the network entity NE of the system SYS. It should however be noted that this example is not limiting and other embodiments could be envisaged in which this tracking entity is comprised in each of the elements of the system SYS. In particular, the communication system SYS can comprise a plurality of tracking entities. According to one embodiment, the system SYS comprises: a first tracking entity comprised in the network entity NE exploited by a mobile operator MNO; and a second tracking entity comprised in a ground station GW exploited by a satellite operator SNO.

In comparison with FIG. 5, the method according to this embodiment further comprises at least one of the steps described below.

During a step SG10, the ground station GW receives, from a certified entity NE, one or more resource delegation authorizations TDD comprising respectively a public key associated with the certified network entity NE (sent during a step SN10).

During a step SG20, the ground station GW sends the authorizations TDD_X, TDD_Y to the satellites SAT_X and SAT_Y (received during steps SX20 and SY20). For example, an authorization TDD can be issued by a mobile operator MNO owning a certain frequency spectrum. In this example, a mobile operator MNO authorizes a satellite operator SNO to exploit all or part of the spectrum owned by the operator MNO to communicate data to terminals UE.

During a step SG40, the ground station GW receives, from the certified entity NE, one or more resource use authorizations TDU comprising respectively a signature determined from a private key associated with the certified entity NE (sent during a step SN40).

During a step SG60, the ground station GW sends the authorizations TDU_X, TDU_Y to the satellites SAT_X and SAT_Y (received during the steps SX60 and SY60). For example, an authorization TDU can be issued by a mobile operator MNO and indicate the usable frequency spectra. According to this example, a mobile operator MNO can authorize, by an authorization TDU_X_W1, the first satellite SAT_X to use a frequency channel between 3.510 GHz and 3.529 GHz in order to communicate with terminals.

According to one embodiment, the signature of a message is obtained by encrypting a hash of the message with the private key. Thus, upon receipt of the message, the recipient simply has to decrypt the signature of the message with the sender's public key, and then compare the decrypted signature to a hash of the message received to ensure the authenticity and the integrity of the message.

The satellites SAT_X and SAT_Y respectively perform a step of authenticating SX61 and SY61 spectrum use authorizations TDU based on the signatures and the public keys received. This embodiment allows to reliably and securely monitor the exploitation of the resources, particularly during inter-satellite cooperation.

During a step SX90, the first satellite SAT_X sends to the second satellite SAT_Y: a cooperation query COOP_QUERY; information TUCP_X; and an authorization TDU_X (received during a step SY90). The information TUCP_X indicates, for example, a number of time-frequency blocks used by the first satellite SAT_X to transmit the query COOP_QUERY; and the authorization TDU_X is used to indicate the spectrum exploited.

During a step SX100, according to one particular embodiment, the first satellite SAT_X receives from the second satellite SAT_Y: a response COOP_ACK; information TUCP_Y; and an authorization TDU_Y (sent during a step SY100). For example, the information TUCP_Y indicates a number of time-frequency blocks used by the second satellite SAT_Y to transmit the response COOP_ACK; and the authorization TDU_Y is used to indicate the spectrum exploited.

During a step SX120, the first satellite SAT_X sends to the second satellite SAT_Y: data COOP_DATA; and information TUDP_X (received during a step SY120). For example, the information TUDP_X indicates a number of time-frequency blocks used by the first satellite SAT_X to transmit the data COOP_DATA.

During a step SX130, according to one embodiment, the first satellite SAT_X sends to said at least one terminal UE: the data DATA_X; the authorizations TDD_X and TDU_X; and information TUDP_X (received during a step SU130). For example, the information TUDP_X indicates a number of time-frequency blocks used by the first satellite SAT_X to send the data COOP_DATA and the data DATA_X; and the authorizations TDD_X, TDU_Y allow the receiver to authenticate the information transmitted as well as to identify the resources used by the first satellite SAT_X.

During a step SY140, the second satellite SAT_Y sends to said at least one terminal UE: the data COOP_DATA; the authorizations TDD_Y and TDU_Y; and information TUCP_Y and TUDP_Y (received during a step SU140). For example, the information TUCP_Y and TUDP_Y indicates a number of time-frequency blocks used by the second satellite SAT_Y to send the response COOP_ACK and the data COOP_DATA; and the authorizations TDD_Y, TDU_Y allow the receiver to authenticate the transmitted information as well as to identify the resources used by the second satellite SAT_Y.

During a step SY150, the second satellite SAT_Y sends, to the first satellite SAT_X, a message COOP_TICKET comprising: the authorizations TDD_Y and TDU_Y; and information TUCP_Y and TUDP_Y. For example, the information TUCP_Y and TUDP_Y indicates all or part of the resources used by the second satellite SAT_Y during the cooperation.

During a step SX150, according to one particular embodiment, the first satellite SAT_X sends, to the second tracking entity comprised in the ground station GW, a message COOP_TICKET comprising: the authorizations TDD_X, TDD_Y, TDU_X and TDU_Y; and information TUCP_X, TUCP_Y, TUDP_X and TUDP_Y (received and transmitted by the ground station GW during a step SG150). In this way, the tracking entity NE is able to accurately track and account for the resources used by the first satellite SAT_X and the second satellite SAT_Y to communicate data to said at least one terminal UE.

During a step SU160, following the receipt of the data DATA_X and COOP_DATA, said at least one terminal UE sends a message COOP_TICKET to the first tracking entity comprised in the network entity NE (received during a step SN160). The message COOP_TICKET comprises: the authorizations TDD_X, TDD_Y, TDU_X and TDU_Y; and information TUCP_X, TUCP_Y, TUDP_X and TUDP_Y, received from the satellites SAT_X and SAT_Y. In this way, the tracking entity NE is able to track the resources used by the satellites to communicate data to the terminal and to prove that a communication has been actually performed.

In the embodiments described with reference to FIG. 8, the satellites SAT_X and SAT_Y belong to the same constellation. However, the method described above also applies to the embodiments in which the cooperation entity is common to several satellite operators SNOs and/or several mobile operators MNOs.

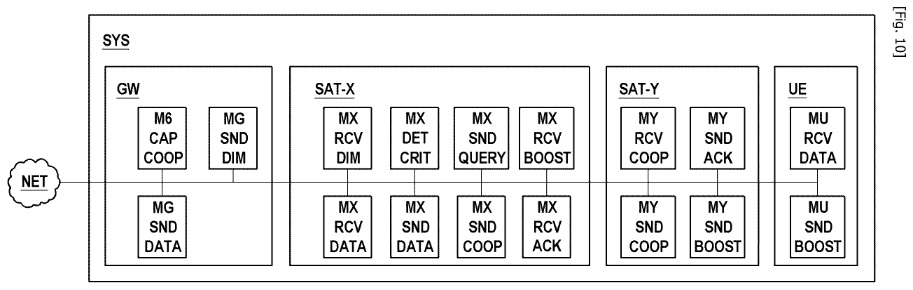

FIG. 9 schematically represents one example of software and hardware architecture of a communication system according to one embodiment of the invention.

As illustrated in FIG. 9, according to one embodiment, the ground station GW comprises at least one of the following modules: a communication module COM_NET_GW configured to communicate with the communication network NET; and a communication module COM_GW_SAT configured to communicate with at least one of the satellites SAT_X, SAT_Y and SAT_Z.

As illustrated in FIG. 9, according to one embodiment, the satellites SAT_X and SAT_Y respectively comprise at least one of the following modules: a communication module COM_GW_SAT configured to communicate with the ground station GW; a communication module COM_SAT_SAT configured to communicate with at least one other satellite; and a plurality of communication modules COM_SAT_UE (i.e. a communication module per spot of the satellite) configured to communicate with said at least one terminal UE.

As illustrated in FIG. 9, according to one embodiment, a said terminal UE comprises at least one of the following modules: a communication module COM_SAT_UE configured to communicate with at least satellites SAT_X and SAT_Y; and a communication module COM_UE_NET configured to communicate with the network.

According to one embodiment, one or more elements of the communication system SYS respectively have the hardware architecture of a computer. Consider an element ELT of the communication system SYS. According to this embodiment, the element ELT includes a processor PROC, a random access memory, a read-only memory MEM, and a non-volatile memory. The memory MEM constitutes an information medium in accordance with the invention, readable by a computer and on which a computer program is recorded. The computer program includes instructions for the implementation of the steps performed by the element ELT of a method according to the invention, when the computer program PROG is executed by the processor. The computer program defines the functional modules represented below in FIG. 10, which rely on or control the hardware elements thereof.

FIG. 10 schematically represents one example of functional architecture of a communication system according to one embodiment of the invention.

The following reference signs allow, for each of the modules of the communication system, to identify the element comprising this module: The references starting with MG are used for the modules of the ground station GW; MX for the first satellite SAT_X; MY for the second satellite SAT_Y; MU for said at least one terminal UE.

As illustrated in FIG. 10, according to one embodiment, the ground station GW comprises at least one of the following modules:
a determination module MG_CAP_COOP for determining the information COOP_DIM;
a sending module MG_SND_DIM for sending the information COOP_DIM; and;
a sending module MG_SND_DATA for sending the data DATA.

As illustrated in FIG. 10, according to one embodiment, the first satellite SAT_X comprises at least one of the following modules:
a receiving module MX_RCV_DIM for receiving the information COOP_DIM;
a determination module MX_DET_CRIT for determining the criterion COOP_CRIT;
a sending module MX_SND_COOP for sending the data COOP_DATA;
a sending module MX_SND_QUERY for sending the query COOP_QUERY;
a receiving module MX_RCV_ACK for receiving the response COOP_ACK;
a receiving module MX_RCV_DATA for receiving the data DATA;
a sending module MX_SND_DATA for sending the data DATA_X;
a receiving module MX_RCV_BOOST for receiving the information BOOST.

As illustrated in FIG. 10, according to one embodiment, the second satellite SAT_Y comprises at least one of the following modules:
a receiving module MY_RCV_QUERY for receiving the query COOP_QUERY;
a sending module MY_SND_ACK for sending the response COOP_ACK;
a receiving module MY_RCV_COOP for receiving the data COOP_DATA; and
a sending module MY_SND_COOP for sending the data COOP_DATA.

As illustrated in FIG. 10, according to one embodiment, a said terminal UE comprises at least one of the following modules:
a receiving module MU_RCV_DATA for receiving the data DATA_X and/or COOP_DATA; and;
a sending module MU_SND_BOOST for sending the information BOOST;

The term “module” can correspond to both a software component and a hardware component or a set of hardware and software components, a software component itself corresponding to one or more computer programs or subprograms or more generally to any element of a program able to implement a function or a set of functions as described for the modules concerned. In the same way, a hardware component corresponds to any element of a set of hardware able to implement a function or a set of functions for the module concerned (integrated circuit, smart card, memory card, etc.).

It should be noted that the order in which the steps of a method as described above are linked, particularly with reference to the attached drawings, constitutes only one exemplary embodiment without any limitation, variants being possible. Moreover, the reference signs are not limiting the scope of the protection, their sole function being to facilitate the understanding of the claims.

Those skilled in the art will understand that the embodiments and variants described above constitute only non-limiting examples of implementation of the invention. In particular, those skilled in the art can envisage any adaptation or combination of the embodiments and variants described above in order to meet a very specific need.

1. A method implemented by a first aerial or spatial device to transmit data to at least one terminal, the method comprising:
receiving, from a cooperation entity, information relating to resources of at least one second aerial or spatial device that can be used to transmit data to said at least one terminal; and
in response to a cooperation criterion is being verified, triggering a cooperation with said at least one second device as a function of said information to transmit data to said at least one terminal, said cooperation comprising: sending, to said at least one second device, second data to be transmitted to said at least one terminal.

2. The method according to claim 1 comprising sending, to said at least one second device, a cooperation query to transmit data to said at least one terminal, said cooperation query comprising monitoring data for the implementation of said cooperation.

3. The method according to claim 1, wherein said information relating to the resources of said at least one second device that can be used is updated by said cooperation entity.

4. The method according to claim 1 comprising sending first data to said at least one terminal by using a time-frequency resource used by said at least one second device to transmit the second data to said at least one terminal.

5. The method according to claim 1 comprising sending first data to said at least one terminal by using a time-frequency resource different from a time-frequency resource used by said at least one second device to transmit the second data to said at least one terminal.

6. The method according to claim 1, wherein the first device and said at least one second device belong to a same constellation.

7. The method according to claim 1, wherein the first device and said at least one second device belong to different constellations.

8. The method according to claim 1 comprising receiving information from said at least one terminal, said cooperation criterion being determined based on this the received information.

9. A method implemented by a cooperation entity to communicate with a first aerial or spatial device, the method comprising:
determining information relating to resources of at least one second aerial or spatial device that can be used to transmit data to at least one terminal; and
sending said information to the first device.

10. The method according to claim 9, wherein said information relating to the resources of said at least one second device that can be used is determined from at least one target data transmission rate and from at least one outage probability defined for at least one communication service implemented by the second device.

11. The method according to claim 10, comprising one or more iterations of an update of said information relating to the resources of said at least one second device that can be used from at least one adjusted rate, said at least one adjusted rate being obtained from said at least one target rate and a coefficient.

12. The method according to claim 9, the method comprising:
sending, to the first device, data to be transmitted to said at least one terminal, the data being transmitted to said at least one terminal via said at least one second device; then
sending, to a third aerial or spatial device, data to be transmitted to said at least one terminal.

13. An aerial or spatial device, called first device, adapted to transmit data to at least one terminal, said first device comprising:
a receiving module configured to receive, from a cooperation entity, information relating to resources of at least one second aerial or spatial device that can be used to transmit data to said at least one terminal; and
a sending module configured to, in response to a cooperation criterion being verified, trigger a cooperation with said at least one second device as a function of said information to transmit data to said at least one terminal, said cooperation comprising sending, by the sending module, to said at least one second device, second data to be transmitted to said at least one terminal.

14. A cooperation entity adapted to communicate with a first aerial or spatial device, the cooperation entity comprising:
a determination module configured to determine information relating to resources of at least one second aerial or spatial device that can be used to transmit data to at least one terminal; and
a sending module configured to send said information to the first device.

15. (canceled)
